(19) United States
(12) Patent Application Publication
(10) Pub. No.: US 2006/0112053 A1
(43) Pub. Date: May 25, 2006

(54) Methods and systems for providing knowledge documents

(76) Inventors: Anne Hicks Jeanblanc, Elizabeth, IL (US); James Michael Coffey, Dunlap, IL (US); Benjamin Eugene Newman, Kewanee, IL (US); Reed Alfred Stuedemann, East Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/261,577

(22) Filed: Oct. 31, 2005

Related U.S. Application Data
(63) Continuation-in-part of application No. 09/995,822, filed on Nov. 29, 2001.

(51) Int. Cl. G06N 5/02

(52) U.S. Cl. 706/46

(57) ABSTRACT

Methods and systems for providing knowledge documents are disclosed. In one embodiment, a system may include a community of practice, including members and a knowledge management architecture managing knowledge documents used by the community of practice and maintaining a user profile for each member having criteria reflecting a preferred format for received knowledge documents. The knowledge management architecture may be configured to receive a search request for knowledge documents from a first member. The first member may be associated with a first user profile with first user profile criteria. The knowledge management architecture may also be configured to generate a search result based on the search request. The search result may include one or more of the knowledge documents. Further, the knowledge management architecture may convert a first knowledge document included in the search result to a format compatible with the first user profile criteria and provide the converted knowledge document to the first member.

### CROSS REFERENCE TO RELATED APPLICATIONS

This application is a continuation-in-part of U.S. patent application Ser. No. 09/995,822, filed Nov. 29, 2001, entitled “Knowledge Management System and Method,” which is incorporated herein by reference in its entirety.

Further, this application is related to U.S. patent application Ser. No. ______, filed ______, entitled METHODS AND SYSTEMS FOR MANAGING KNOWLEDGE DOCUMENTS (Attorney Docket No. 08350.5678), U.S. patent application Ser. No. ______, filed ______, entitled METHODS AND SYSTEMS FOR COLLABORATING COMMUNITIES OF PRACTICE (Attorney Docket No. 08350.5680), and U.S. patent application Ser. No. ______, filed ______, entitled METHODS AND SYSTEMS FOR DELIVERING COMMUNITY KNOWLEDGE (Attorney Docket No. 08350.5681), each of which is incorporated by reference in its entirety.

### TECHNICAL FIELD

The present invention relates generally to knowledge management, and more particularly, to a method and system for gathering, managing, and sharing knowledge in a community of practice.

### BACKGROUND

Organizations, such as businesses, often rely heavily on knowledge within the organization itself. One example of this reliance is training. Experienced employees are often called upon to train new employees. In addition to training the new employee how to do the job, the experienced employee may also share advice based on lessons the experienced employee learned by doing the same job. Another example is a “resident expert.” Often an employee, through education or experience or both, has become particularly knowledgeable about a topic. Other employees who need advice or information about this topic may contact the “resident expert.” Other examples of important corporate knowledge are internal standards. Internal standards for a procedure or product may be generated and updated by the persons in the organization who are responsible for the procedure or product. The internal standards may be used by the responsible team to ensure that procedures and policies are followed. Further, the internal standards may be used as a guide to quickly train new members of the team. Finally, internal standards may be used by other divisions of the organization as a basis for forming their own standards or for interacting with the responsible team.

Organizational knowledge may be very valuable to an organization. A number of problems exist, however, which may cause the organization to not fully utilize, or even realize the extent of, this organizational knowledge. One problem is that organizational knowledge is often not captured from the knowledgeable employee and documented for use by others. Unless knowledge is documented, it is possible that others within the organization will not be able to determine where particular organizational knowledge resides, and thus the knowledge will be underutilized. Additionally, if a knowledgeable employee leaves the organization without first documenting his knowledge, that knowledge will be lost to the organization. Another problem is that, while an employee may be particularly knowledgeable, until that knowledge has been identified, other persons in the organization (including in other divisions of the organization) may be unaware of the existence of the “resident expert.”

Further, many organizations are becoming increasingly globalized. For example, one company may have corporate headquarters located in one state, research and development facilities located in a second state, manufacturing operations in a number of other states, and retail facilities worldwide. Part of the reason for this globalization is the ease with which communications between these locations may occur. While the technology exists to permit interaction and collaboration among persons at different locations in the organization, current systems do not provide sufficient structure to identify sources of knowledge and enable interaction between persons having knowledge and persons seeking knowledge. Not only does the organizational knowledge need to be globally accessible, but interaction must also be supported.

Finally, in addition to merely capturing the knowledge, it is most effective to provide for interaction and collaboration based on the knowledge. Rather than simply requesting persons to submit any knowledge that they might have, even if directed to a particular topic, it is effective to instead focus the interested persons on a project, goal, or purpose. From the interaction and collaboration that follows based on the project, the knowledge can be captured and documented.

In addition to systems that permit limited interaction, systems also exist that permit some documentation of organizational knowledge. Some of these systems may include mere cataloging of information or mere answering of questions. These systems, however, are limited to a single facet of knowledge, such as “best practices” or internal standards. The systems may also be limited in the persons that may participate. Additionally, these systems are often relatively static and non-interactive. For example, some of these systems may be simply a list of frequently asked questions. At best, some systems refer a user to the person who supplied the knowledge that the user is accessing. The currently available systems do not provide sufficient interaction and/or collaboration with other users to achieve a common purpose based on the knowledge, nor do the current systems provide a dynamic, constantly updating knowledge system. One exemplary existing system is described in U.S. Pat. No. 5,924,072, entitled “Knowledge Management System and Method.” This system provides for the submission of knowledge items by a user, as well as the use of the knowledge items by a second user. The second user may submit feedback about the knowledge item. However, there is no interaction or collaboration between the users; further, the system is designed merely to acquire knowledge.

Additionally, existing systems do not provide an environment that enables knowledge to be provided to members in a language format specific to each member.

The present invention is directed to overcoming one or more of the problems or disadvantages associated with the prior art.

### SUMMARY OF THE INVENTION

Methods and systems for providing knowledge documents are disclosed. In one embodiment, a system may include a community of practice, including members and a knowledge management architecture managing knowledge documents used by the community of practice and maintaining a user profile for each member having criteria reflecting a preferred format for received knowledge documents. The knowledge management architecture may be configured to receive a search request for knowledge documents from a first member. The first member may be associated with a first user profile with first user profile criteria. The knowledge management architecture may also be configured to generate a search result based on the search request. The search result may include one or more of the knowledge documents. Further, the knowledge management architecture may convert a first knowledge document included in the search result to a format compatible with the first user profile criteria and provide the converted knowledge document to the first member.

In another embodiment, a method for providing collaborative communications in a community of practice environment is disclosed. The environment may include a community of practice including members each being associated with a user profile and a knowledge management system maintaining user profiles for each of the members. Each user profile may include user profile criteria indicating a preferred format a respective member prefers to have communications provided them within the community of practice. The method may include receiving a request to transmit communications from a first member to a second member and determining whether the communications includes data in a format that is not compatible with the second member's user profile criteria. Further, the method may include converting the communications to the preferred format associated with the second member's user profile criteria based on the determination and sending the converted communications to the second member.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an exemplary community of practice consistent with one embodiment of the present invention;

FIG. 2 is a block diagram of an exemplary knowledge management architecture consistent with one embodiment of the present invention;

FIG. 3 is a block diagram of an exemplary knowledge management system consistent with one embodiment of the present invention;

FIG. 4 is an exemplary flow chart illustrating a method for creating a community of practice, consistent with one embodiment of the present invention;

FIG. 5 is an exemplary flow chart illustrating a method for managing knowledge, consistent with one embodiment of the present invention;

FIG. 6 is a flowchart of an exemplary search request process, consistent with certain disclosed embodiments; and

FIG. 7 is a flowchart of an exemplary collaborative communication session process, consistent with certain disclosed embodiments.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

A system and method are provided to capture, manage, and share knowledge within an organization. The system and method of the present invention are not limited to knowledge management within an organization, but may be used to facilitate the capture, management, and sharing of knowledge within any organized group of persons working for common goals or purposes. Specifically, a community of practice is formed to facilitate the capturing, managing, and sharing of knowledge. A community of practice is a group of persons (most typically in a single organization) grouped together for a common purpose or to achieve a common goal. For example, a community of practice may be formed to develop a training program for employees in a division, or to create a set of standards for a new product line. A community of practice is not necessarily based on formal divisions within the organization, but may include members from many divisions who are involved in an aspect of the organization or a particular project. Also included in the community of practice is a set of procedures, best practices and standards that the community of practice can use in working towards the purpose or goal. After the goal or purpose is accomplished, the community of practice can continue as an organizational resource.

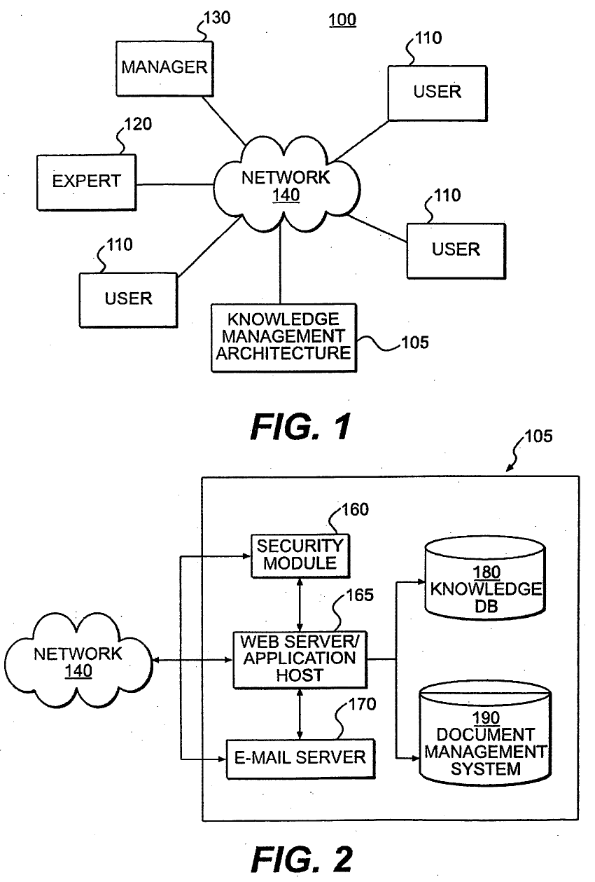

FIG. 1 illustrates an exemplary community of practice 100, consistent with one embodiment of the present invention. As shown in FIG. 1, community of practice 100 includes a knowledge management architecture 105, a plurality of users 110, an expert 120, and a community of practice manager 130, all interconnected by network 140. Knowledge management architecture 105 facilitates interaction among the participants (namely, users 110, expert 120, and manager 130) in community of practice 100. Knowledge management architecture 105 also maintains knowledge entries. Users 110 interact with other users 110, expert 120, and community of practice manager 130 via network 140, for example, by posing questions or responding to the questions of others. Users 110 may also access knowledge entries via knowledge management architecture 105. Further, users 110 may submit their own knowledge to be added to knowledge management architecture 105. Users 110 may interface with community of practice 100 using personal computers, work stations, or other devices connected to network 140.

Expert 120 is similar to user 110, but has been identified within community of practice 100 as having special knowledge. Users 110 may obtain the status of expert 120 through, inter alia, significant participation in a community of practice. In addition to interacting with other entities in community of practice 100 and submitting and accessing knowledge, expert 120 may participate in approving knowledge submitted by users 110. Although only one expert 120 is illustrated in FIG. 1, community of practice 100 may include a plurality of experts.

Community of practice manager 130 functions as the facilitator and moderator for community of practice 100. Community of practice manager 130 may be responsible for review, validation, and dissemination of knowledge in the community of practice. Community of practice 100 may include one or more community of practice managers.

Network 140 may be the Internet, a wireless local area network (LAN), or another type of network. Network 140 is intended in its broadest sense to encompass any communications system.

FIG. 2 is a block diagram illustrating an exemplary knowledge management architecture 105. Knowledge management architecture 105 may include a security module 160, a Web server/application host module 165, an e-mail server 170, a knowledge database 180, and a document management system 190. Security module 160, Web server module 165, and e-mail server 170 interface with network 140. Web server module 165 is connected to e-mail server 170. Web server module 165 is also connected to knowledge database 180 and document management system 190. It is contemplated that a knowledge management system of the present invention may include some or all of the components of FIG. 2.

Security module 160 may determine what type of access each entity in community of practice 100 has with respect to knowledge database 180 and/or the document management system 190. For example, users 110 may access knowledge in knowledge database 180 but may not alter the knowledge. Further, users 110 who wish to add knowledge to knowledge database 180 may require approval of the knowledge before the knowledge is added. Expert 120 and/or community of practice manager 130, on the other hand, may be permitted access to knowledge database 180, as well as the ability to alter knowledge database 180. Further, security module 160 may be used to permit different levels of access to different users, based on, for example, subscription status. For example, anonymous users 110 may be permitted access to only a portion of knowledge database 180, whereas registered users 110 may access the entire knowledge database. While security is important, access is important to achieve interaction and collaboration, and security should be minimized if possible.

Web server/application host module 165 includes an interface for entities to access knowledge database 180, as well as document management system 190. Further, web server module 165 may include additional capabilities, such as collaboration tools to permit entities in community of practice 100 to work together, bulletin boards to permit entities in community of practice 100 to communicate with each other, and/or search engines to provide efficient access to specific knowledge entries in knowledge database 180 or document management system 190. Web server module 165 may also permit entities in community of practice 100 to submit knowledge to be added to knowledge base 180. An exemplary web server application is ColdFusion® by Allaire.

E-mail server 170 provides users 110, expert 120, and community of practice manager 130 with updated information from knowledge management architecture 105. For example, when a new knowledge entry has been approved, e-mail server 170 may forward the knowledge entry to the other entities in the community of practice 100. Alternatively, e-mail server 170 may forward notice of the availability of a new knowledge entry, tool, or standard that may be accessed using Web server module 165.

Knowledge database 180 contains approved knowledge entries, standards, tools, and other information used by entities in community of practice 100. Knowledge management architecture 105 may include one or more knowledge databases 180.

Document management system 190 provides access to documents stored in a number of different formats, such as word processing format, spread sheet format, or presentation format. Document management system 190 permits more rapid capture of knowledge, because documents do not need to be converted before they can be shared with the community of practice.

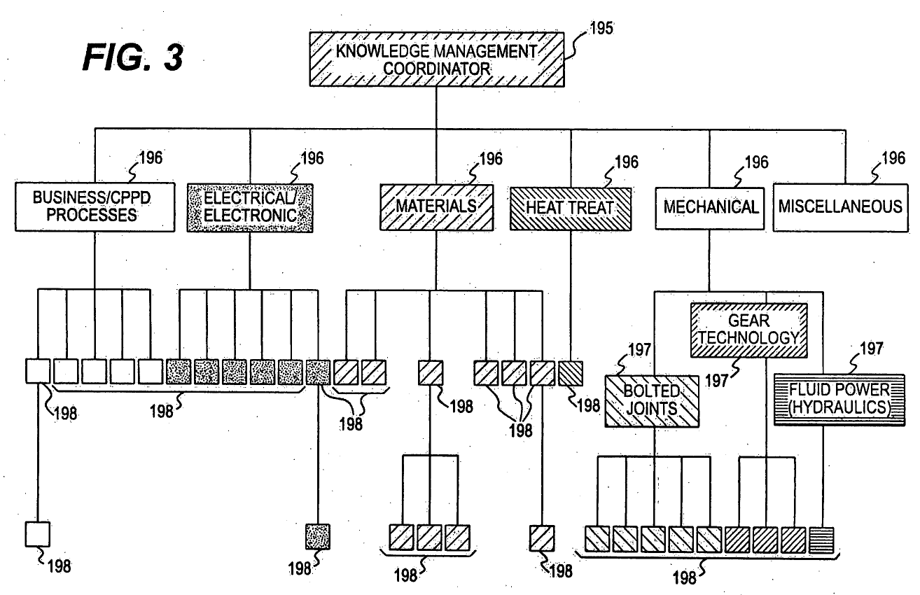

FIG. 3 illustrates an exemplary knowledge management system for an organization, consistent with one embodiment of the present invention. For example, the knowledge management system may include a knowledge management coordinator 195, one or more community groups 196, and one or more communities of practice 198. The one or more community groups may also include one or more sub-community groups 197. Knowledge management coordinator 195 oversees community groups 196 and communities of practice 198. Community groups 196 are logical divisions that may facilitate operation of communities of practice 198 by grouping communities of practice 198 with similar interests or goals. In the exemplary knowledge management system of FIG. 3, the community groups 196 include “Business/CPPD Processes,” “Electrical/Electronic,” “Materials,” “Heat Treat,” “Mechanical,” and “Miscellaneous.” As illustrated in FIG. 3, the “Mechanical” community group may include sub-community groups 197, which include more specific subject areas.

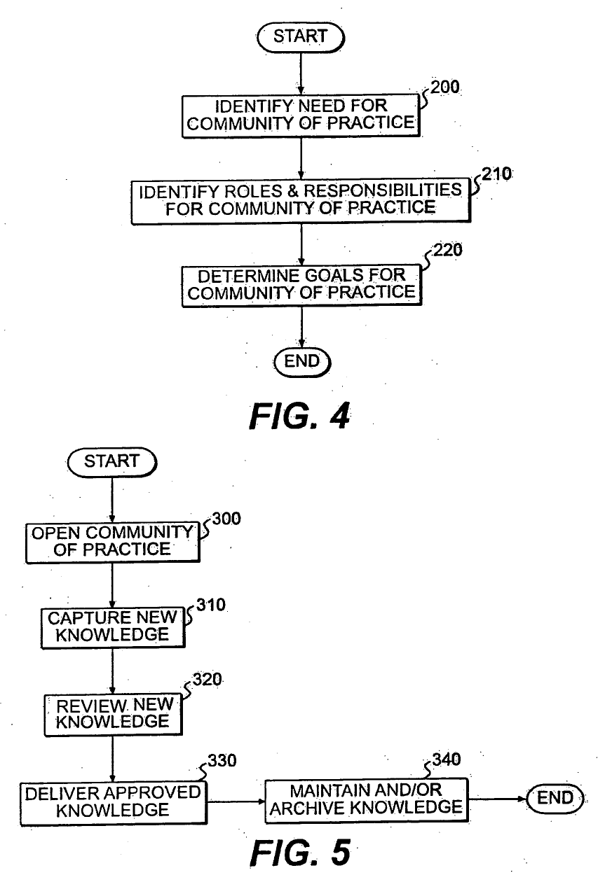

FIG. 4 illustrates an exemplary flow chart of a method for establishing a community of practice. First, a need for a community of practice is identified, for example, by identifying knowledge building activities (step 200). Knowledge building activities may include any activity where problems may be identified, solutions may be generated, or any other body of knowledge may be gathered or created. For example, knowledge building activities may include problem-solving activities, team meetings, firm-wide retreats, or new product designs or launches. A knowledge management coordinator, who may oversee the operation of a number of communities of practice for the organization, may be notified of the new community of practice and may assist with the formation of the new community of practice.

Next, the roles and responsibilities of the community of practice are identified (step 210). One or more community of practice managers may be identified to organize the community of practice and to facilitate and moderate interaction among participants. One or more experts may be associated with the community of practice. In addition, relevant documentation may be identified and collected. For example, existing design guides, training materials, tools, standards, and regulations may be added to the knowledge database (or alternatively, be made available through the document management system). Depending on the roles of various participants in the community of practice, security levels and requirements may also be established. Responsibilities of an expert may include approving knowledge entries submitted by users or periodically answering questions posted via the community of practice. Responsibilities of a manager may include approving knowledge entries submitted by users, organizing interaction between participants in the community of practice, and encouraging participants to work towards the achievement of the goals of the community of practice. It may also be determined to what extent users may participate, and whether different users may have different access to knowledge database. Participants in the community of practice may, if appropriate, receive training in order to enhance their usage of the community of practice.

Goals for the community of practice are then determined (step 220). The goals of the community of practice may include the goals or purposes for which the community of practice was formed. For example, goals may be product-oriented, such as creating a design guide for a new product or developing a software product for testing a new product. Goals may also be information-oriented, such as distributing information from recent symposia or meetings or collecting feedback from organizational locations worldwide to determine required improvements. Further, goals may be career-oriented, such as developing training programs for new employees and providing networking between persons in the organization. Another method for determining goals for the community of practice includes determining what knowledge is missing or what knowledge should be updated. The goal of a community of practice, as encompassed by the present invention, is not the mere cataloging of information within an organization nor the mere answering of questions.

FIG. 5 is an exemplary flowchart illustrating a method for capturing, managing, and sharing knowledge in an established community of practice. Once a community of practice is established, the community of practice is opened (step 300). The community of practice may be advertised within the organization, for example, via company newsletters, e-mails, or other media. Persons wishing to join a community of practice may be asked to enroll or subscribe in the community of practice. There may be different levels of membership, each having a level of security associated. Alternatively, all users may have access to all parts of the knowledge database associated with the community of practice.

The community of practice then may capture new knowledge (step 310). New knowledge may be submitted by users, or may be gathered from interactions (for example, via electronic bulletin board or other collaborative tool) between users via knowledge management architecture 105. Knowledge may include explanations of a situation, commentary on a situation, suggestions for improving a situation, links or references to supporting material, or suggestions of persons who may have additional knowledge. Knowledge may also include information about the person supplying the knowledge. Knowledge may be left in its original format, including word processing, spread sheet, or presentation format. Knowledge that is not in electronic format may be scanned to create an electronic document that may then be attached to electronic mail or messages. By leaving knowledge in the original format, the substance can be reviewed and fine-tuned prior to any conversion.

Next, the captured knowledge is reviewed (step 320). The knowledge may be reviewed to determine if the material is accurate, complete, and/or validated. The knowledge entry may be reviewed by the community of practice manager and/or the expert. Alternatively, the knowledge entry may be reviewed by a review team consisting of a number of persons and resources from within the organization or community of practice.

Once the knowledge entry has been approved, it is delivered (step 330). Delivery of knowledge may include e-mailing the entry to all users who have subscribed to the community of practice. Alternatively, the knowledge entry may be made available for browsing via a Web site associated with the community of practice. Delivered knowledge may also include information about validation and future plans. Further delivered knowledge may include the capability to comment on the knowledge, as well as links to obtain more information or related knowledge. The delivered knowledge may have the capability to be forwarded to non-community of practice members.

Finally, knowledge entries are maintained and/or archived (step 340). Specifically, knowledge entries, such as standards, design guides, training materials, or other procedural information may be validated and updated based on the new knowledge entries. Maintenance of these knowledge entries may include version tracking or other organizational procedures to ensure that the current documents and procedures are being followed. Knowledge entries may also be archived for later use.

The community of practice may also be monitored based on standard metrics, such as usage (such as number of times the knowledge database is accessed), time to market, or other criteria. Once it has been determined that the goals or purposes of the community of practice have been achieved, the community of practice can function as an effective resource for the organization.

### ALTERNATIVE EMBODIMENTS

Methods and systems consistent with the disclosed embodiments enable members to share knowledge to achieve one or more goals of a community of practice. In certain embodiments, members may request information, such as knowledge, from architecture 105. Further, members may exchange information over network 140. Members, however, may have different profiles, and thus require information to be received in different formats. Accordingly, the disclosed embodiments may associate user profiles with each member that specify one or more characteristics associated with the respective member, including a preferred format for information (e.g., knowledge) that is received over network 140, from architecture 105, other members, or any other entity or component of a community of practice environment.

In certain embodiments, a member may define criteria associated with their user profile through architecture 105. As such, architecture 105 may include a memory device that stores user profile information for each member of a community of practice. The user profile information may be updated as the size of the community of practice changes (e.g., new members added or existing members removed). In one embodiment, a member may request from architecture 105 their user profile for review. The member may request architecture 105 to modify their user profile based on their personal preference(s). For instance, a member may define a user profile criterion that identifies a particular language the member desires information to be provided from architecture 105, other members, etc. Thus, a member may define a user profile requesting knowledge documents to be provided in English, French, Spanish, or any other desired language. Further, the member may define a user profile to request knowledge documents in a particular software format or presentation format, such as a particular word processing file, particular HTML configuration, etc. The disclosed embodiments contemplate the user profiles including criteria that defines any type of characteristic associated with delivered knowledge to the member. For instance, a user profile criteria may identify a type of speaking language, a type of computer programming language, a type of format associated with data files, and a type of format associated with word processing documents that the user prefers to have received knowledge delivered.

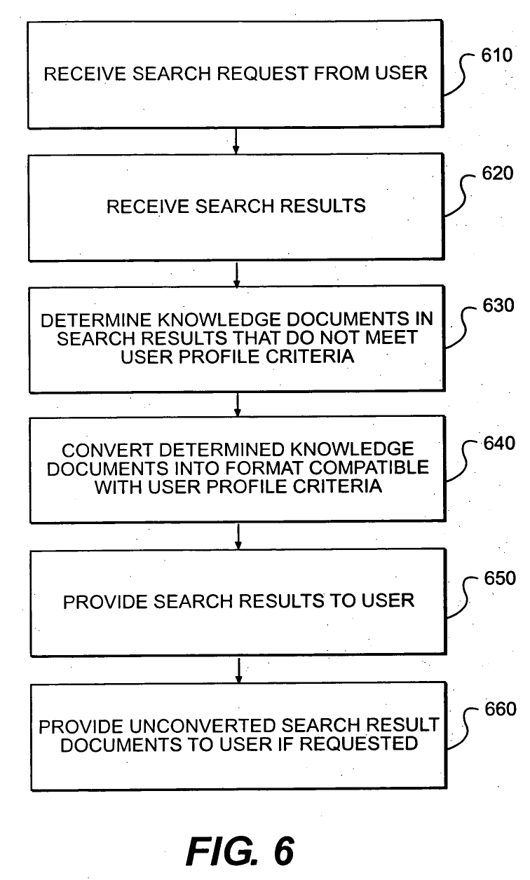

FIG. 6 shows a flow chart of an exemplary knowledge document request process, consistent with certain disclosed embodiments. As explained, a member (i.e., user) may request knowledge from architecture 105. The requested knowledge may be one or more knowledge documents stored in knowledge database 180. Accordingly, in one embodiment, architecture 105 may receive a request from a user for a knowledge document (Step 610). The request may include information identifying a particular knowledge document, a search query with one or more search terms, a user identifier, and/or any other type of information associated with a search request for information.

In response to the request, architecture 105 searches knowledge database 180 for the knowledge document identified in the request and eventually receives search results (Step 620). The search results may include one or more knowledge documents that meet search criteria included in the search request received in Step 610. In one embodiment, architecture 105 may be equipped with a search engine that, when executed by a processor, performs a search of database 180 for knowledge documents identified by the user request. Alternatively, if the request included one or more search terms, the search engine may search database 180 for knowledge documents that include data related to the one or more search terms. In other embodiments, architecture 105 may search other components for the knowledge document, such as a database connected to network 140. Further, architecture 105 may direct another processing component to perform the search for the requested knowledge document. Accordingly, the disclosed embodiments are not limited to the above examples, and any type of search process and system configuration may be implemented to locate knowledge requested by a member in a community of practice.

Architecture 105 may determine which, if any, knowledge documents in the search results do not meet criteria associated with the user's profile (Step 630). For example, architecture 105 may review the user profile associated with the user to determine which language format the user prefers knowledge documents to be presented. Further, architecture 105 analyzes the data included in each of the knowledge documents included in the search results to determine the type of language the data is stored, such as English, French, Spanish, Japanese, etc. Architecture 105 may then compare each knowledge document with the user profile criteria to determine whether the reviewed knowledge document is presented in a format consistent with the format identified in the user's profile. In one embodiment, architecture 105 separates the knowledge documents that do not meet the user profile criteria from those knowledge documents that do meet the user profile criteria. Architecture 105 may separate the knowledge document by storing each set of documents in separate memory locations of a memory device(s), such as database 180. Alternatively, architecture 105 may set a flag for each identified non-compatible document identified in a list of the knowledge documents included in the search results collected by the search engine. It should be noted that architecture 105 may use any type of process and components to distinguish knowledge documents that meet the user profile criteria from those documents that do not meet the criteria.

In one embodiment, architecture 105 may convert each knowledge document that does not meet the user profile criteria into a format compatible with the user profile criteria (Step 640). For example, architecture 105 may convert the text of a word processing file, an e-mail file, etc., to the language specified in the user profile criteria.

Once the separated non-compatible knowledge documents are converted to the appropriate user profile format, architecture 105 may provide the search results to the user (Step 650). Architecture 105 may provide the search results using any type of transmission process, medium, etc. For instance, the search results including the converted knowledge documents may be provided to the user in a data file attached to an e-mail, posted on a web-site accessible by the user or by downloading the search results to a browser application executed on a computer system operated by the user, etc.

In other embodiments, architecture 105 may offer the user an option to receive unconverted knowledge documents. To this end, architecture 105 may provide the unconverted knowledge documents to the user in a manner similar to that described above in connection with the converted knowledge documents (Step 660).

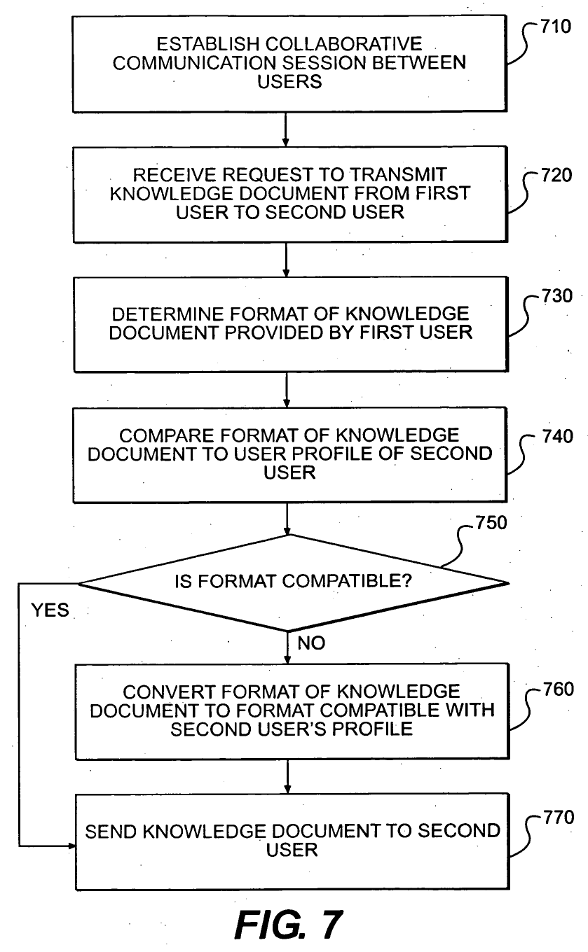

In another embodiment, methods and systems are provided that enable members of a community of practice (or members of different communities of practice) to communicate in real time. The disclosed embodiments allow these communications to be converted to match a receiving member's profile criteria, thus allowing two or more members to collaborate with information that is in a different format (e.g., language, word processing format, etc.). FIG. 7 shows a flowchart of an exemplary collaborative communication process associated with knowledge documents, consistent with certain disclosed embodiments.

Initially, architecture 105 may receive a request or an indication that two members (i.e., a first and second user) wish to establish a communication session. In response, architecture 105 may establish a collaborative communication session between a first and second user (Step 710). Establishing the collaborative communication session may including setting a protocol with each user that directs communications to architecture 105 for processing in accordance with certain disclosed embodiments.

Once the session is established, architecture 105 may receive a request to transmit, for example, a knowledge document from a first user to second user (Step 720). In response, architecture 105 may determine the format of the knowledge document provided by the first user (Step 730). For instance, architecture may determine that the first user may be offering a knowledge document that is written in a first language (e.g., computer language, speaking language (e.g., Spanish), etc.). Next, architecture 105 may compare the format of the knowledge document to the user profile of the second user (Step 740). If the format is compatible with the second user's profile criteria (Step 750; Yes), architecture 105 may forward the knowledge document to the second user (Step 770). On the other hand, if the format is not compatible (Step 750; No), architecture 105 may convert the format of the knowledge document to a format that is compatible with the second user's profile in a manner consistent with the above disclosed embodiments (Step 760). Once converted, architecture 105 may send the knowledge document to the second user (Step 770).

It should be noted that although FIG. 7 is described in connection with a knowledge document, the disclosed collaborative communication process is not restricted to knowledge documents. Any communications may be converted in real time by architecture 105. For example, e-mail data, text messages, etc. may be converted to match a receiving user's profile to allow the receiving user (e.g., second user) to view the information included in the communication according to their preferred profile criteria. Also, more than two users may be included in a collaborative session. Thus, architecture 105 may convert a communication to meet receiving users' profiles that are configured by the receiving users. For instance, a first receiving user of a set of users in a collaborative session may request knowledge documents to be converted into English, while a second receiving user in the set may request knowledge documents to be converted into French.

### INDUSTRIAL APPLICABILITY

Knowledge management using the community of practice system and method of the current invention provide a way to permit interaction and collaboration between persons who have knowledge and persons who are seeking knowledge. The present invention supports internal collaboration among team members in an open environment that encourages participation. Further, the present invention provides for documentation of the knowledge, so that the knowledge is available globally and can be easily identified by those who are seeking it. Other benefits of the present invention include the ability to maintain up-to-date standards and best practices, the ability to quickly train new employees, and the ability to collaborate on an organization-wide level. Up-to-date standards and practices can be kept in a central electronic location, accessible by anyone in the organization, and when updates are required, suggestions can be solicited through the community of practice. New employees can be quickly trained, as all of the tools, standards, best practices, and training material are also available in one location. New employees also have the ability to interact with other employees to answer any questions that might arise. Collaboration on an organization-wide level is possible because e-mails containing new knowledge may be routed immediately to all members of the community of practice, while all tools and other materials are available in one location.

The present invention has clear benefits in helping divisions within an organization share information. For example, one division of a company may have identified a problem, but due to time or budget constraints, was unable to create a software program to analyze the problem. A second division of the company had created a spread sheet tool to analyze the problem; however, the tool was stored locally within the second division and was not accessible to the rest of the company, including the division that had identified the problem. In accordance with an embodiment of the present invention, a user in the second division may have submitted the tool to the community of practice where it was reviewed by experts and approved for use throughout the company. Since putting the tool into use, the tool may have been modified by various users in the community of practice based on their experiences. Thus, the division experiencing the problem would have this valuable corporate resource to draw upon.

As another example of the effective use of the present invention, a user in one division of an organization may post a question to an electronic bulletin board associated with the community of practice. In reply, the user may receive responses from persons throughout the organization. Some of the responses may provide answers or suggestions to the user's question; other responses may direct the user to a person knowledgeable about the topic or may direct the user to documentation existing in the knowledge database.

The community of practice system and method of the present invention has virtually unlimited potential uses. A community of practice may be established whenever there is a business requirement. In certain organizations, this may require notifying and obtaining support from a corporate coordinator. Once necessary approvals are obtained, a community of practice manager, associated experts, and any procedures, specifications, training, and standards that the community of practice would be responsible for are identified. Security levels and requirements would be determined for the community, as well as specific goals for the community to accomplish. Training may be provided as necessary for the community. The community of practice would then be opened in the organizational knowledge management system. Once the new community of practice is advertised, membership and subscriptions of users would be accepted. The progress of the community of practice can be measured with standard metrics. Once the original goals are achieved, the community of practice will continue to be an effective corporate resource.

Methods and systems consistent with the disclosed embodiments may be applied to community of practice environments to allow knowledge to be converted into a format compatible with user defined profile criteria. Therefore, a community of practice member may search for knowledge documents managed by architecture 105 and stored in different formats and receive results (e.g., requested knowledge documents) in a converted format compatible with their profile criteria. Further, the disclosed embodiments provide for real time collaboration between members each having different user profile criteria. Therefore, a first member may communicate in real time with a second member over a network, where communications received by each member is converted according to each respective member's profile.

In another embodiment, each member of a community of practice may update their user profile criteria to identify more than one format that is preferred by the respective member. Thus, a member may identify several languages (e.g., English, Spanish, French, etc.) that the member prefers communications to be received, as well as several different presentation formats, computer languages, etc. Further, embodiments enable architecture 105 to provide an option for a member to rank the different formats identified in the member's user profile criteria. For example, a member may specify through architecture 105 whether they prefer to have a first speaking language be considered for conversion before a second speaking language. Alternatively, architecture 105 may be configured to allow a member to dynamically request architecture 105 to convert received communications to a different format that may or may not be identified in that member's user profile criteria. For example, during a collaborative communication session with another member, a receiving member (e.g., a member receiving communications from a sending member) may send a request to architecture 105 to specify a type of format the receiving member prefers to have the communications converted. This embodiment may also be provided with search requests. That is, a member may identify a particular format in a search request when requesting a knowledge document search request from architecture 105. Alternatively, or additionally, the member may request architecture 105 to convert search results to another format after receiving converted search results from architecture 105 in response to a search request.

Other aspects and features of the present invention can be obtained from a study of the drawings, the disclosure, and the appended claims.

What is claimed is:

1. A system for providing knowledge documents, comprising:
a community of practice including members; and
a knowledge management architecture managing knowledge documents used by the community of practice and maintaining a user profile for each member having criteria reflecting a preferred format for received knowledge documents, the knowledge management architecture configured to:
receive a search request for knowledge documents from a first member, the first member associated with a first user profile with first user profile criteria
generate a search result based on the search request, the search result including one or more of the knowledge documents,
convert a first knowledge document included in the search result to a format compatible with the first user profile criteria, and
provide the converted knowledge document to the first member.

2. The system of claim 1, wherein the first user profile criteria identifies a particular format of knowledge documents the first member prefers to receive.

3. The system of claim 1, wherein the knowledge management architecture is further configured to provide to the first member unconverted knowledge documents included in the search results.

4. The system of claim 1, wherein the knowledge management architecture is further configured to determine which of the knowledge documents included in the search request are already in a format compatible with the first user profile criteria.

5. The system of claim 2, wherein the particular format of knowledge documents identified in the first user profile criteria includes at least one of a type of speaking language, a type of computer programming language, a type of format associated with data files, and a type of format associated with word processing documents.

6. The system of claim 1, wherein the community of practice includes a second member associated with a second user profile having second user profile criteria, and wherein the knowledge management architecture is further configured to:
convert communications between the first member and a second member of the community of practice such that a communication sent to the first user is converted to a format compatible with the first user profile criteria and a communication sent to the second user is converted to a format compatible with the second user profile criteria.

7. The system of claim 6, wherein the knowledge management architecture is further configured to:
establish a collaborative communication session between the first and second user; and
monitor communications between the first and second user such that the architecture can convert communications that do not meet the profile criteria of either of the first and second member that is receiving the communications.

8. The system of claim 6, wherein the communications include at least one of one or more knowledge documents, one or more e-mails, one or more text messages, and one or more data files.

9. A system for providing collaborative communications in a community of practice environment, including:
a community of practice including members each being associated with a user profile; and
a knowledge management system maintaining user profiles for each of the members, each user profile including user profile criteria indicating a preferred format a respective member prefers to have communications provided them within the community of practice, wherein the knowledge management system is configured to:
receive a request to transmit communications from a first member to a second member,
determine whether the communications includes data in a format that is not compatible with the second member's user profile criteria,
convert the communications to the preferred format associated with the second member's user profile criteria based on the determination, and
send the converted communications to the second member.

10. The system of claim 9, wherein the knowledge management system is further configured to:
establish a collaborative communications session between the first and second member to allow the first and second members to exchange information within the community of practice.

11. The system of claim 9, wherein the communications is a knowledge document.

12. The system of claim 9, wherein the knowledge management system is configured to convert the communications to a second format based on a request received from the second member to convert the communications to the second format.

13. A method of providing knowledge documents in an environment including a community of practice including members and a knowledge management architecture managing knowledge documents used by the community of practice and maintaining a user profile for each member having criteria reflecting a preferred format for received knowledge documents, the method performed by the knowledge management architecture comprising:
receiving a search request for knowledge documents from a first member, the first member associated with a first user profile with first user profile criteria;
generating a search result based on the search request, the search result including one or more of the knowledge documents;
converting a first knowledge document included in the search result to a format compatible with the first user profile criteria; and
providing the converted knowledge document to the first member.

14. The method of claim 13, wherein the first user profile criteria identifies a particular format of knowledge documents the first member prefers to receive.

15. The method of claim 13, further including:
providing to the first member unconverted knowledge documents included in the search results.

16. The method of claim 13, further including:
determining which of the knowledge documents included in the search request are already in a format compatible with the first user profile criteria.

17. The method of claim 14, wherein the particular format of knowledge documents identified in the first user profile criteria includes at least one of a type of speaking language, a type of computer programming language, a type of format associated with data files, and a type of format associated with word processing documents.

18. The method of claim 13, wherein the community of practice includes a second member associated with a second user profile having second user profile criteria, and wherein the method further includes:
converting communications between the first member and a second member of the community of practice such that a communication sent to the first user is converted to a format compatible with the first user profile criteria and a communication sent to the second user is converted to a format compatible with the second user profile criteria.

19. The method of claim 18, further including:
establishing a collaborative communication session between the first and second user; and
monitoring communications between the first and second user such that the architecture can convert communications that do not meet the profile criteria of either of the first and second member that is receiving the communications.

20. The method of claim 18, wherein the communications include at least one of one or more knowledge documents, one or more e-mails, one or more text messages, and one or more data files.

21. A method for providing collaborative communications in a community of practice environment including a community of practice including members each being associated with a user profile and a knowledge management system maintaining user profiles for each of the members, each user profile including user profile criteria indicating a preferred format a respective member prefers to have communications provided them within the community of practice, the method comprising:
receiving a request to transmit communications from a first member to a second member;
determining whether the communications includes data in a format that is not compatible with the second member's user profile criteria;
converting the communications to the preferred format associated with the second member's user profile criteria based on the determination; and
sending the converted communications to the second member.

22. The method of claim 21, further including:
establishing a collaborative communications session between the first and second member to allow the first and second members to exchange information within the community of practice.

23. The method of claim 21, wherein the communications is a knowledge document.

24. The method of claim 21, further including converting the communications to a second format based on a request received from the second member to convert the communications to the second format.
